(19) United States
(12) Patent Application Publication
(10) Pub. No.: US 2008/0111425 A1
(43) Pub. Date: May 15, 2008

(54) Uninterruptible power supply with an illuminator

(76) Inventor: Cheng-Chun Chang, Hsin-Tien City (TW)

Correspondence Address: TROXELL LAW OFFICE PLLC, 5205 LEESBURG PIKE, SUITE 1404, FALLS CHURCH, VA, 22041, US

(21) Appl. No.: 11/819,702

(22) Filed: Jun. 28, 2007

(30) Foreign Application Priority Data
Sep. 15, 2006 (TW) 095216468

(51) Int. Cl. H02J 7/00; F21L 4/08

(52) U.S. Cl. 307/66; 362/183; 320/137

(57) ABSTRACT

An uninterruptible power supply includes a body holding a host circuit board and having a power input terminal and multiple power output terminals, and a battery holder detachably inserted into an accommodation chamber of the body to electrically connect and holding a battery and a lamp. When the battery holder is inserted into the accommodation chamber of the body, power contacts of the battery holder are respectively disposed in contact with respective power contacts in the body for supplying battery power from the at least one battery to the power output terminals of the body. When the battery holder is removed from the accommodation chamber of the body and the lamp is switched on, the battery power of the battery holder is transmitted to the lamp, driving the lamp to give off light.

### BACKGROUND OF THE INVENTION

1. Field of the Invention

The present invention relates to an uninterruptible power supply and more particularly, to an uninterruptible power supply with an illuminator.

2. Description of the Related Art

An UPS (Uninterruptible Power Supply) is a battery backup which, working like an emergency light, maintains a continuous supply of electric power to connected equipment when utility power is not available. An UPS has a precision system design that shortens the time in which the supply of electric power is switched from utility power to the battery backup. Actually, an UPS works not only when utility power failed but also when encounters sags, spikes, surges, noise, high/low voltage transients, i.e., an UPS automatically stabilizes the voltage and removes the noise to provide to the connected equipment a stable and clean power source environment when the quality of utility power cannot support the connected equipment for normal functioning.

Because commercial UPSs are much more expensive than other emergency power supply devices and the function of commercial UPSs is superior to other emergency power supply devices, commercial UPSs are commonly used to protect important equipments, such as computer systems, monitoring instruments, firefighting equipments, medical implements, and etc. to satisfy their critical requirement for power supply quality. Nowadays, UPS has been commonly used in high-tech industry and computer industry as one of the requisite equipment that can solve power supply problems thoroughly.

Commercial UPSs commonly have a box-like shape, and are comprised of battery, circuit board, monitoring software, relay, and etc. During installation of an UPS, AC power supply is connected to the UPS, and then the UPS is connected to the equipment, for example, computer and monitor. Upon detection of interruption of AC power supply or a voltage abnormality by the UPS, the power circuit is switched to backup battery within a very short time to maintain a continuous supply of electric power to connected equipment. By means of the supply of electric power from the backup battery, the user has a buffer time of several tens of minutes to finish the current job and to turn off the machine subject to the normal Turn Off procedure, preventing data loss or system damage. At this time, the backup battery has residual power in it when the user turned off the machine subject to the regular procedure. However, because a battery has a limited service life and the backup battery of a commercial UPS is directly mounted inside the housing, the residual power in the backup battery cannot be fully utilized.

Further, Taiwan Patent No. 547780, entitled “Mobile Battery Box of an UPS”, discloses a battery box formed of two half shells and defining an inside accommodation space in which a battery is set in horizontal. The UPS has an opening through which the battery box is detachably mounted in the UPS. This design simply allows for convenient replacement or maintenance of the battery inside the battery box without any other added functions.

### SUMMARY OF THE INVENTION

The present invention has been accomplished under the circumstances in view. According to one aspect of the present invention, the uninterrupted power supply comprises a body and a battery holder. The body comprises a host circuit board, the host circuit board comprising a main loop, the main loop comprising a charging circuit and a current converting circuit, a power input terminal and at least one power output terminal disposed at one side thereof and electrically connected to the main loop of the host circuit board, an accommodation chamber, and two power contacts disposed in the accommodation chamber and electrically connected to positive and negative terminals of the main loop of the host circuit board. The battery holder fits the accommodation chamber and is detachably inserted into the accommodation chamber, comprising a battery circuit holding at least one battery, two power contacts respectively electrically connected to positive and negative terminals of the battery circuit, a lamp electrically connected to the battery circuit, and an on/off switch for switching on/off the lamp. When the battery holder is inserted into the accommodation chamber of the body, the power contacts of the battery holder are respectively disposed in contact with the power contacts of the body for supplying battery power from the at least one battery to the at least one output terminal of the body. When the battery holder is removed from the accommodation chamber of the body and the switch is switched on, the battery power of the at least one battery is transmitted to the lamp, driving the lamp to give off light.

According to another aspect of the present invention, the lamp can be a LED lamp, PL type fluorescent lamp, or incandescent lamp.

According to still another aspect of the present invention, the battery holder further comprises a reflector mounted around the lamp for reflecting the light of the lamp toward the outside of the battery holder, and a lens covered on a front opening of the battery holder over the reflector and the lamp.

According to still another aspect of the present invention, the body has a handle disposed outside the accommodation chamber.

### BRIEF DESCRIPTION OF THE DRAWINGS

FIG. 1 is an exploded view of an uninterruptible power supply with an illuminator in accordance with the present invention.

FIG. 2 is a sectional assembly view of the uninterruptible power supply with an illuminator in accordance with the present invention.

FIG. 3 is a perspective view of the uninterruptible power supply with an illuminator in accordance with the present invention.

### DETAILED DESCRIPTION OF THE PREFERRED EMBODIMENT

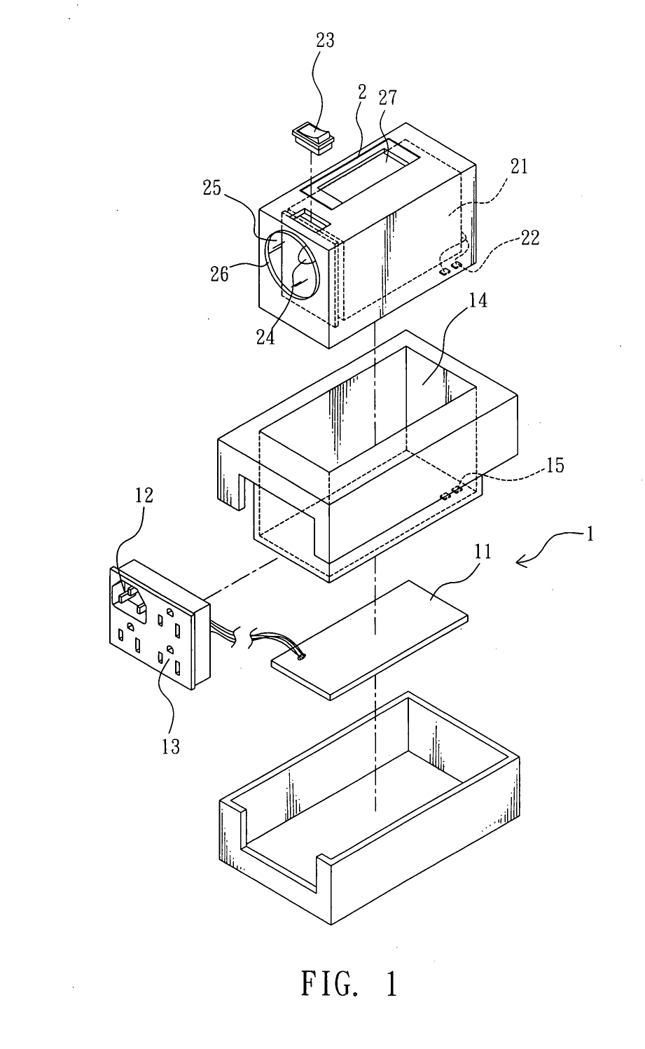

Referring to FIG. 1, an uninterruptible power supply with an illuminator in accordance with the present invention is shown comprised of a body 1 and a battery holder 2.

The body 1 has mounted therein a host circuit board 11, a power input terminal 12 and at least one power output terminal 13 at one side for AC input/output. The host circuit board 11 has a charging circuit for charging the battery holder 2. The body 1 further has an accommodation chamber 14 into which the battery holder 2 is detachably inserted. When the battery holder 2 is inserted into the accommodation chamber 14, it is electrically connected to the host circuit board 11. Further, two power contacts 15 are provided in the accommodation chamber 14 at a suitable location, for example, at the bottom side.

The battery holder 2 is a box fitting the accommodation chamber 14 in size, having set therein at least one battery 21. The battery holder 2 further has two power contacts 22 disposed on the outside. When the battery holder 2 is inserted into the accommodation chamber 14, the two power contacts 22 of the battery holder 2 are kept in contact with the power contacts 15 in the accommodation chamber 14, and therefore the battery 21 is electrically connected to the positive and negative terminals of the main loop of the host circuit board 11. When the power input terminal 12 is connected to utility power (city power supply), AC power supply is rectified by the rectifying circuit (not shown) of the host circuit board 11 into DC power supply to charge the battery 21 through the power contacts 15 in the accommodation chamber 14 and the power contacts 22 of the battery holder 2. When the supply of utility power is interrupted or failed, the DC power supply of the battery 21 of the battery holder 2 is transmitted to the host circuit board 11 through the power contacts 22 of the battery holder 2 and the power contacts 15 in the accommodation chamber 14, and then converted into AC power supply by the converting circuit (not shown) of the host circuit board 11 for output through one power output terminal 13. At this time, the user can turn off the machine, for example, the computer, subject to the normal Turn Off procedure, preventing data loss or system damage.

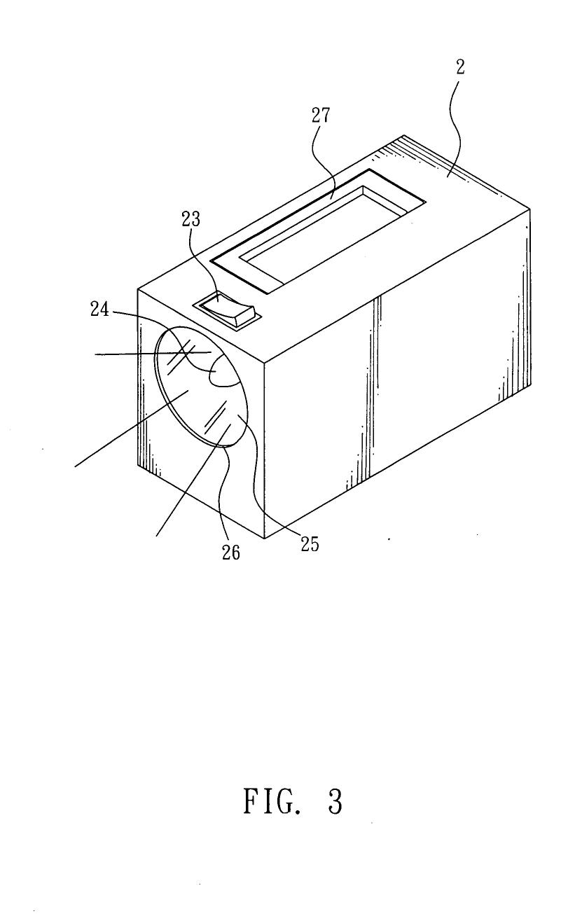

Further, the battery holder 2 has an on/off switch 23 and a lamp 24 electrically connected to the battery circuit. The lamp 24 can be a LED lamp, long lasting PL type fluorescent lamp, or incandescent lamp. When turned off the machine, the user can remove the battery holder 2 from the accommodation chamber 14, and then switch on the on/off switch 23, driving on the lamp 24 to give off light. Thus, the user can use the battery holder 2 has a hand lamp for illumination (see FIG. 3). The battery 21 discharges electric power during working of the lamp 24, and therefore the service life of the battery 21 can be extended.

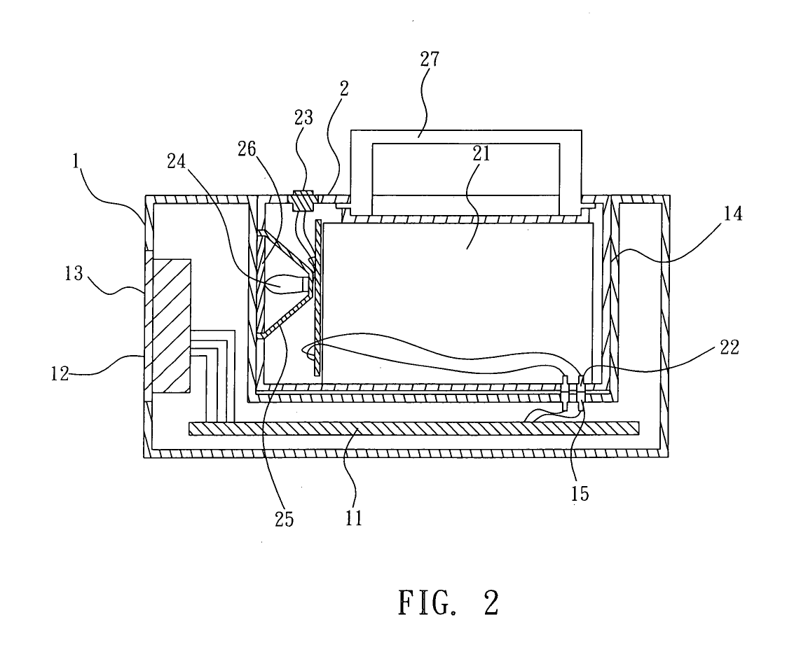

Referring to FIG. 2 and FIG. 1 again, a reflector 25 is mounted in the battery holder 2 around the lamp 24 to reflect the light of the lamp 24 toward the outside of the battery holder 2. A protective lens 26 is covered on the reflector 25 to protect the lamp 24. Further, a handle 7 is pivoted to the top side of the battery holder 2 for carrying by hand. Through the handle 7, the user can remove the battery holder 2 from the accommodation chamber 14 of the body 1 with less effort.

If the battery holder 2 is not inserted into the accommodation chamber 14 of the body 1 after the supply of utility power is resumed, utility power is transmitted through the power input terminal 12 and the main loop of the host circuit board 11 to the power output terminal 13 and then the connected machine, providing the connected machine, for example, computer, with the necessary working voltage. However, when the battery holder 2 is inserted into the accommodation chamber 14 of the body 1 to force the contacts 15 into contact with the contacts 22, the charging circuit of the host circuit board 11 immediately charges the battery 21 of the battery holder 2.

As stated above, the battery holder is detachably mounted in the body of the UPS so that the user can replace or repair the battery conveniently. When the connected machine is turned off subject to the normal Turn Off procedure, the user can remove the battery holder from the accommodation chamber of the body and switch on the lamp for use as a hand lamp for illumination.

Although a particular embodiment of the invention has been described in detail for purposes of illustration, various modifications and enhancements may be made without departing from the spirit and scope of the invention.

What is claimed is:

1. An uninterruptible power supply comprising:
a body, said body comprising a host circuit board, said host circuit board comprising a main loop, said main loop comprising a charging circuit and a current converting circuit, a power input terminal and at least one power output terminal disposed at one side thereof and electrically connected to the main loop of said host circuit board for input of utility power and power output respectively, an accommodation chamber, and two power contacts disposed in said accommodation chamber and electrically connected to positive and negative terminals of said main loop of said host circuit board;
a battery holder fitting said accommodation chamber and detachably inserted into said accommodation chamber, said battery holder comprising a battery circuit holding at least one battery, two power contacts respectively electrically connected to positive and negative terminals of said battery circuit, a lamp electrically connected to said battery circuit, and an on/off switch for switching on/off said lamp;
wherein when said battery holder is inserted into said accommodation chamber of said body, the power contacts of said battery holder are respectively disposed in contact with the power contacts of said body for supplying battery power from said at least one battery to said at least one output terminal of said body upon failure or abnormal supply of utility power; when said battery holder is removed from said accommodation chamber of said body and said switch is switched on, the battery power of said at least one battery is transmitted to said lamp, driving said lamp to give off light.

2. The uninterruptible power supply as claimed in claim 1, wherein said lamp is selected from one of a LED lamp, a PL type fluorescent lamp, and an incandescent lamp.

3. The uninterruptible power supply as claimed in claim 1, wherein said battery holder further comprises a reflector mounted around said lamp for reflecting the light of said lamp toward the outside of said battery holder.

4. The uninterruptible power supply as claimed in claim 3, wherein said battery holder further comprises a lens covered on a front opening of said battery holder over said reflector and said lamp.

5. The uninterruptible power supply as claimed in claim 1, wherein said body has a handle disposed outside said accommodation chamber.
